(19) United States
(12) Patent Application Publication
(10) Pub. No.: US 2012/0044117 A1
(43) Pub. Date: Feb. 23, 2012

(54) PLANAR ANTENNA APPARATUS

(75) Inventors: Hiroshi MATSUKUMA, Kanagawa (JP); Keiji YOSHIDA, Fukuoka (JP); Haruichi KANAYA, Fukuoka (JP)

(73) Assignee: RENESAS ELECTRONICS CORPORATION, Kanagawa (JP)

(21) Appl. No.: 13/028,600

(22) Filed: Feb. 16, 2011

(30) Foreign Application Priority Data
Feb. 16, 2010 (JP) 2010-031222
Feb. 23, 2010 (JP) 2010-037604
Dec. 24, 2010 (JP) 2010-287159

(51) Int. Cl. H01Q 13/10; H01Q 1/50

(52) U.S. Cl. 343/771; 343/770

(57) ABSTRACT

A ground conductor is formed by a conductor pattern placed to a surface of a dielectric substrate, and includes a first and a second opening. A transmission line is formed over the dielectric substrate by the conductor pattern. The transmission line supplies a signal to a first and a second peripheral conductor respectively surrounding the first and the second opening. The first and second opening are arranged axis-symmetrically with respect to the transmission line. Opening areas of the first and the second opening are determined so that, due to loop currents supplied by the transmission line flowing through the first and the second peripheral conductor, a region including the first opening and the first peripheral conductor operates as a magnetic field radiation first loop radiating element, and a region including the second opening and the second peripheral conductor operates as a magnetic field radiation second loop radiating element.

### CROSS-REFERENCE TO RELATED APPLICATIONS

This application is based upon and claims the benefit of priorities from Japanese patent applications Nos. 2010-031222, filed on Feb. 16, 2010; 2010-037604, filed on Feb. 23, 2010; and 2010-287159, filed on Dec. 24, 2010, the disclosures of which are incorporated herein in their entirety by reference.

### BACKGROUND

The present invention relates to a planar antenna apparatus which can be used for wireless communications.

Along with increased diversity in applications of a wireless communication apparatus, smaller size, higher performance, and higher efficiency are desired for the wireless communication apparatus. The size of the wireless communication apparatus largely depends on the size of the antenna. There is an increasing need of further improvement of radiation efficiency especially for a small size planar antenna that can be placed over a dielectric substrate as a layout pattern.

WO 2006/126320 discloses a nonresonant planar slot dipole antenna apparatus. A configuration and characteristics of this antenna apparatus are explained below. FIG. 11 is a plan view illustrating the configuration of the antenna apparatus disclosed in WO 2006/126320. FIG. 12 is a plan view showing an antenna unit 101 of the antenna apparatus shown in FIG. 11. The antenna apparatus shown in FIG. 11 includes the antenna unit 101 and a matching unit 106. The matching unit 106 performs impedance matching between the antenna unit 101 and an external circuit (signal source) which is not shown.

The antenna unit 101 as a slot dipole antenna is formed by providing openings (slots) 102 and 103 in a conductor 105 formed over a dielectric substrate. Accordingly, the lower layer dielectric substrate is exposed in the openings 102 and 103 shown in FIGS. 11 and 12. In the example of FIGS. 11 and 12, the antenna unit 101 is connected to the matching unit 106 via a Coplanar Waveguide (CPW). Since it is a tiny nonresonant antenna, in FIGS. 11 and 12, an antenna length L is far smaller than a wavelength λ. (that is, L<<λ). WO 2006/126320 discloses an analysis result of impedance Za of the antenna unit 101 by an electromagnetic field simulation. According to the analysis result, slopes of radiation resistance Ra and reactance Xa of the antenna unit 101 will be constant near a center frequency (for example, 5.0 GHz) of a radio signal. Accordingly, an equivalent circuit of this antenna unit 101 can be represented by a series circuit of the radiation resistance Ra and the reactance Xa as shown in FIG. 13.

The matching unit 106 includes a transmission line 104 and an inverter 107. The transmission line 104 includes two parallel signal lines. As for these signal lines, one end is connected to the antenna unit 101, and the other end is connected to an external circuit (signal source) via the inverter 107. The matching unit 106 is designed using characteristic impedance Z1 and electrical length θ₀ of the transmission line 104. The characteristic impedance Z1 is calculated according to a design formula of a formula (1). In the formula (1), Qₑ₁ is external Q (coupling amount with an external circuit) of a resonator. The function Sinc(θ) is sinθ/θ. The design formula shown in the formula (1) is calculated based on the condition in which an antenna equivalent circuit with a matching circuit will be equivalent to a circuit based on the filter theory.

$${Z}_{1} = {X}_{a} tan {θ}_{0} \cdot {θ}_{0} = \frac{1}{2} {Sinc}^{- 1} ( \frac{{X}_{a}}{2 {Q}_{e 1} {R}_{a} - {X}_{a}} ) \qquad ( 1 )$$

### SUMMARY

The present inventors have found a problem in the antenna apparatus disclosed in WO 2006/126320 is that it is difficult to improve the radiation efficiency of the antenna unit 101 when the antenna apparatus is mounted on a small size wireless communication apparatus. The reason is explained below. When incident power to the antenna is P_{A}[W], radiation power of the antenna is P_{R}[W], radiation resistance of the antenna is Ra[Ω], and loss resistance is R_{L}[Ω], generally the radiation efficiency η is represented by a formula (2).

$$η = \frac{{P}_{R}}{{P}_{A}} = \frac{Ra}{Ra + {R}_{L}} \qquad ( 2 )$$

The radiation resistance Ra[Ω] of the antenna unit 101 shown in FIG. 12, i.e., the nonresonant planar slot dipole antenna, is represented by a formula (3). In the formula (3), L[μm] is an antenna length and λ[μm] is a wavelength of a radio signal. Therefore, the radiation resistance of the nonresonant planar slot dipole antenna shown in FIG. 12 depends on the antenna length L.

Ra=80π²(L/λ)² (3)

The characteristics of the slot dipole antenna are considered with peripheral conductors (peripheral conductors 111 to 114 of FIGS. 11 and 12) placed around the slot as infinite, ideally. Thus, when assuming to place the planar antenna apparatus of FIG. 11 in a limited area in order to reduce the size of the wireless communication apparatus, it is not easy to extend the antenna length L due to the limitation of area. Accordingly, it is difficult to improve the radiation resistance Ra shown in the formula (3), and it is difficult also to improve the radiation efficiency η that depends on the radiation resistance Ra.

An aspect of the present invention includes a planar antenna apparatus that includes a dielectric substrate, a ground conductor, and a transmission line. The ground conductor is formed by a conductor pattern placed to a surface of the dielectric substrate and includes a first and a second opening. The transmission line is also formed by the conductor pattern. The transmission line supplies a signal to a first and a second peripheral conductor respectively surrounding the first and the second opening. Further, the first and the second opening are arranged axis-symmetrically with respect to the transmission line. Furthermore, opening areas of the first and the second opening are determined so that, due to loop currents that are supplied by the transmission line and flow through the first and the second peripheral conductor, a region including the first opening and the first peripheral conductor operates as a first loop radiating element of a magnetic field radiation type, and a region including the second opening and the second peripheral conductor operates as a second loop radiating element of the magnetic field radiation type.

According to the aspect of the present invention mentioned above, by expanding the areas of the first and the second opening, it is possible to obtain magnetic field radiation type loop antenna characteristics in contrast to the antenna apparatus with electric field radiation type slot dipole antenna characteristics shown in FIG. 11. Note that the radiation efficiency η of the loop antenna depends on the loop area, that is, the opening area of the first and the second opening. Since the planar antenna apparatus according to the aspect of the present invention mentioned above is easy to expand the first and the second openings while suppressing the expansion of the antenna area, it is easy to improve the radiation efficiency η.

According to the aspect of the present invention mentioned above, the radiation efficiency η can be improved while suppressing the expansion of the antenna area.

### BRIEF DESCRIPTION OF THE DRAWINGS

The above and other aspects, advantages and features will be more apparent from the following description of certain embodiments taken in conjunction with the accompanying drawings, in which:

FIG. 1 is a plan view showing an example of a configuration of an antenna apparatus according to a first embodiment of the present invention;

FIG. 2 is a plan view showing a part of the antenna apparatus (i.e. an antenna unit 1) shown in FIG. 1;

FIGS. 3A and 3B are plan views of a planar antenna apparatus for which a simulation was performed;

FIG. 4 illustrates a simulation result of electric field distribution of a planar antenna apparatus according to a comparative example;

FIG. 5 illustrates a simulation result of current distribution of the planar antenna apparatus according to the comparative example;

FIG. 6 illustrates a simulation result of electric field distribution of the planar antenna apparatus according to the first embodiment of the present invention;

FIG. 7 illustrates a simulation result of current distribution of the planar antenna apparatus according to the first embodiment of the present invention;

FIG. 8 is a plan view showing an example of a configuration of the antenna apparatus according to a second embodiment of the present invention;

FIG. 9 is a plan view showing a state of current and a magnetic field flowing through the antenna unit 21 shown in FIG. 8;

FIGS. 10A and 10B are conceptual diagrams showing the magnetic field and magnetic flux density generated in the antenna unit 21 shown in FIG. 8;

FIG. 11 is a plan view of an antenna apparatus according to a related art;

FIG. 12 is plan view showing a part of the antenna apparatus (i.e. an antenna unit 101) shown in FIG. 11; and

FIG. 13 illustrates an equivalent circuit of the antenna unit 101 shown in FIG. 12.

### DETAILED DESCRIPTION

Hereinafter, specific embodiments incorporating the present invention are described with reference to the drawings. In each drawing, the same components are denoted by the same reference numerals, and repeated explanation is omitted as necessary for the clarity of the explanation.

### First Embodiment

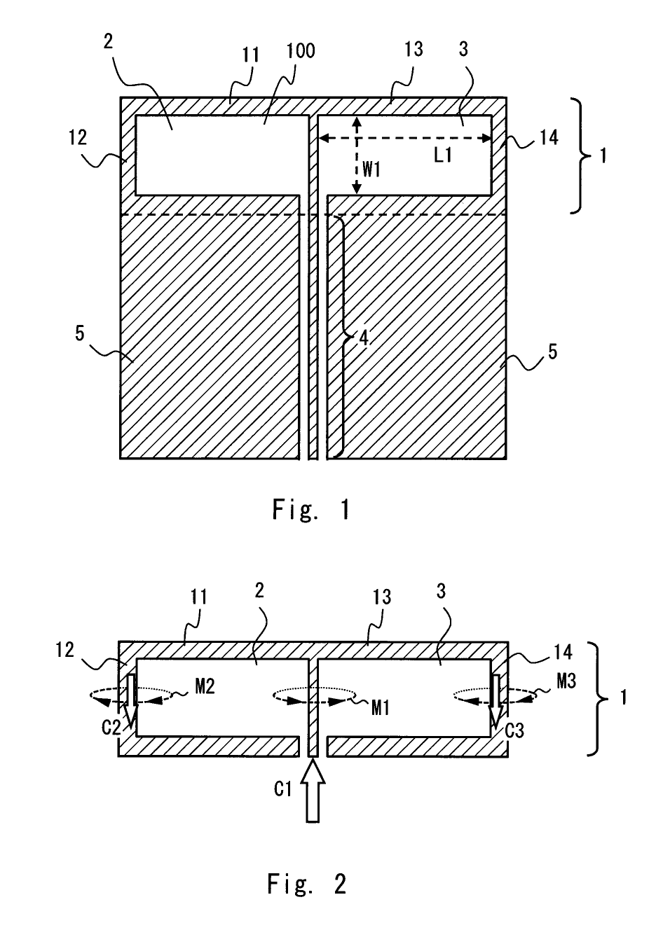

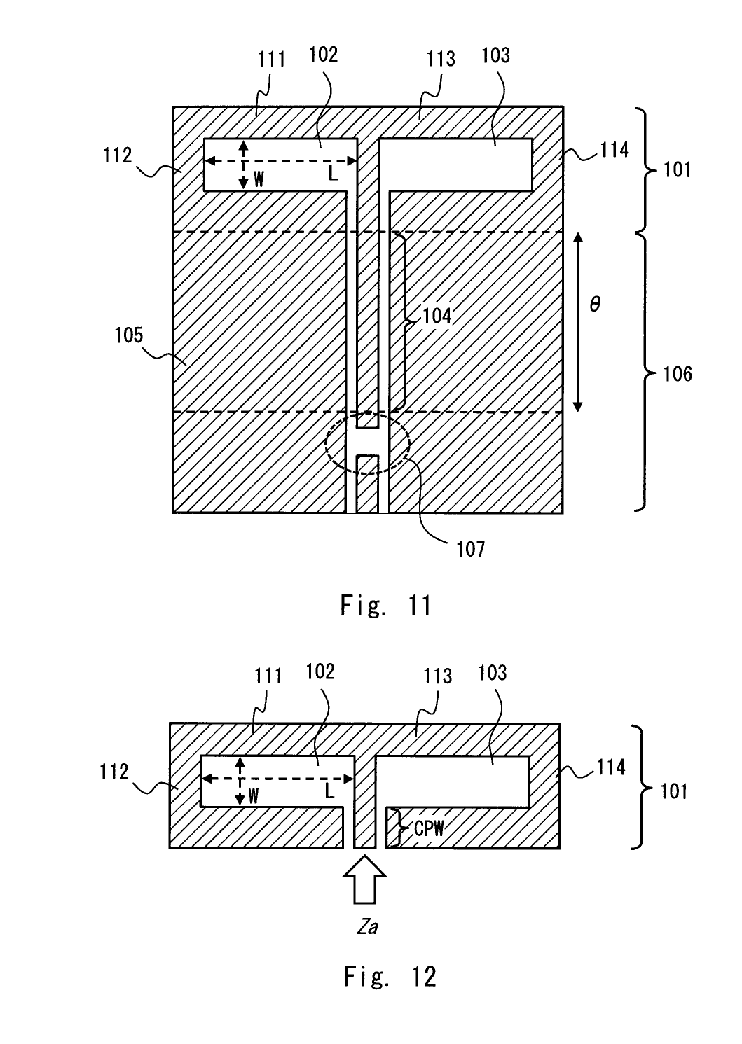

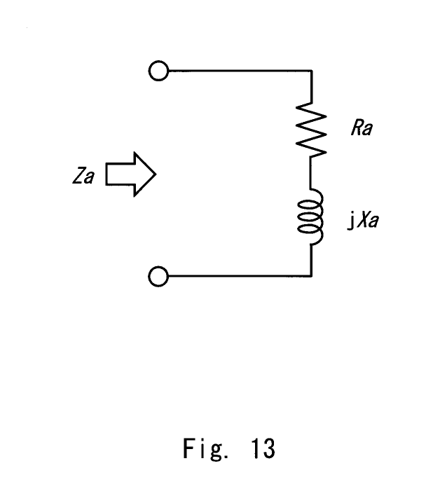

FIG. 1 is a plan view showing an example of a configuration of a planar antenna apparatus according to the first embodiment of the present invention. A schematic configuration of the antenna apparatus of FIG. 1 is same as that of the planar antenna apparatus shown in FIGS. 11 and 12. To be specific, an antenna unit 1 is formed by providing openings (slots) 2 and 3 in a GND conductor 5 that is formed by a conductor pattern placed over a dielectric substrate 100. The lower layer dielectric substrate 100 is exposed in the openings 2 and 3 shown in FIG. 1. The openings 2 and 3 are arranged axis-symmetrically with respect to a transmission line 4. The antenna unit 1 is connected to an external circuit (signal source) via the transmission line 4 and an impedance matching circuit (not shown). In the example of FIG. 1, the transmission line 4 is a coplanar waveguide. The impedance matching circuit (not shown) may be similar to the inverter 107 or the like shown in FIG. 11.

However, specific arrangement, shape, and opening area of the openings 2 and 3 of the planar antenna apparatus according to this embodiment shown in FIGS. 1 and 2 are different from the ones shown in FIG. 11. Specifically in this embodiment, a width of peripheral conductors (conductors 11 to 14) of the antenna unit 1 is narrowed to the extent that is not influenced by a skin effect, i.e. current reduction due to an insufficient surface depth, at a desired radio frequency. Then, the opening area of the openings 2 and 3 is expanded. By adopting such configuration, the radiation characteristics (that is, magnetic field radiation type) of a tiny loop antenna, not the radiation characteristics (that is, electric field radiation type) of a tiny dipole antenna, dominate the radiation characteristics of the antenna unit 1. It is considered that this radiation characteristics are brought about by loop current (a first loop) which flows through the peripheral conductors 11 and 12 of the opening 2, and loop current (a second loop) which flows through the peripheral conductors 13 and 14 of the opening 3. Accordingly, the region including the opening 2 and its peripheral conductors 11 and 12 operates as a first loop radiating element, and the region including the opening 3 and its peripheral conductors 13 and 14 operates as a second loop radiating element.

As for the tiny loop antenna, the width of the peripheral conductors 11 to 14 should be determined not to block the flow of the loop current. Therefore, in the case of the tiny loop antenna, unlike the tiny slot dipole antenna, it is not necessary to reserve the width of the peripheral conductors 11 to 14 more than necessary. The radiation resistance of the tiny loop antenna is proportional to the opening area (i.e. area surrounded by the current loop). Thus, according to the antenna apparatus of this embodiment, the width of the peripheral conductors 11 to 14 is reduced so as to expand the openings 2 and 3 instead. Then the radiation efficiency can be improved while suppressing the area expansion of the planar antenna. Therefore, the antenna apparatus according to this embodiment is suitable for reducing the size of the wireless communication apparatus.

The state of magnetic field radiation of the antenna unit 1 is explained hereinafter. FIG. 2 shows the loop current flowing through the antenna unit 1 and the magnetic field generated by the loop current. Forward current C1 is supplied to the antenna unit 1 from the transmission line 4. The forward current C1 generates a forward magnetic field M1. The forward current C1 is divided into return current C2 which flows through the peripheral conductors 11 and 12 (the first loop) of the opening 2, and return current C3 which flows through the peripheral conductors 13 and 14 (the second loop) of the opening 3. A return magnetic field M2 in the first loop is generated by the return current C2 which flows through the first loop. Similarly, a return magnetic field M3 in the second loop is generated by the return current C3 which flows through the second loop. Due to the return magnetic fields M2, M3, and the forward magnetic field M1, magnetic flux is localized in the antenna unit 1, and strong electromagnetic waves are emitted to space.

Further, as shown in FIGS. 1 and 2, by adopting the layout of arranging the openings 2 and 3 axis-symmetrically with respect to the transmission line 4, the return current C2 and C3 flows through the shortest path to the GND conductor 5 along the conductor edge due to the nature of high-frequency current. The flow of the current C2 and C3, which is opposite direction to the forward current C1, suppresses propagation of the magnetic field in the transmission line 4 and disorder of electromagnetic wave radiation of the antenna unit 1.

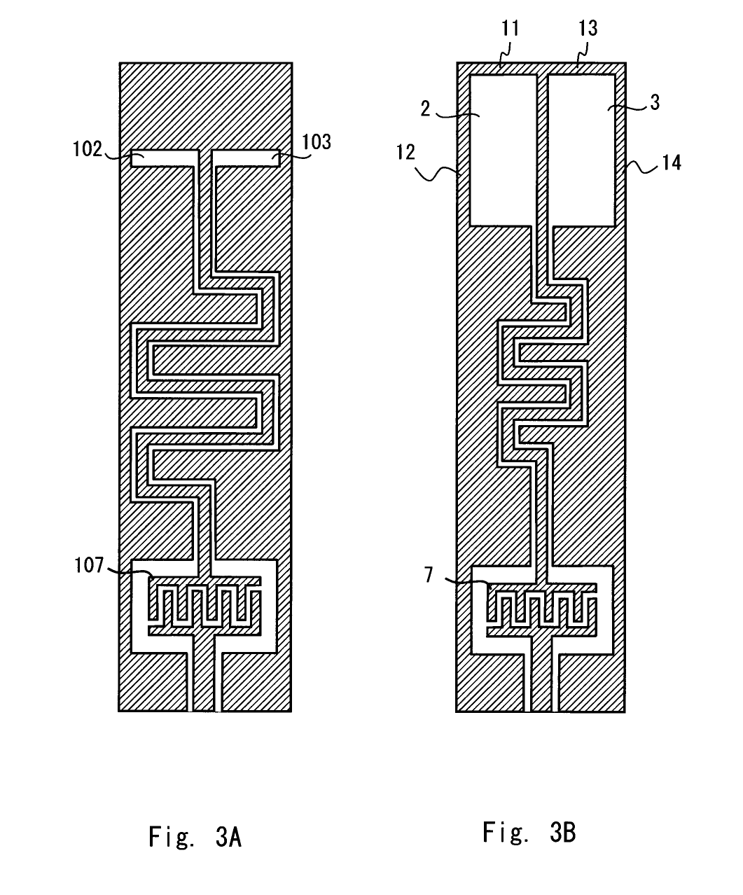

Hereinafter, a simulation result of the electric field distribution and the current distribution of the planar antenna apparatus according to this embodiment which has the loop antenna characteristics is explained. As a comparative example, a simulation result of the electric field distribution and the current distribution of the planar antenna apparatus which has the dipole antenna characteristics shown in FIG. 11 is also explained. FIGS. 3A and 3B are plan views of the planar antenna apparatus for which the simulation was performed. FIG. 3A shows the planar antenna apparatus with the dipole antenna characteristics shown in FIG. 11. FIG. 3B shows the planar antenna apparatus according to this embodiment with the loop antenna characteristics. As compared with FIG. 3A, in the antenna apparatus shown in FIG. 3B, the area of the peripheral conductors 11 to 14 is reduced, and the openings 2 and 3 are expanded. The inverter 7 may have the same configuration as the inverter 107.

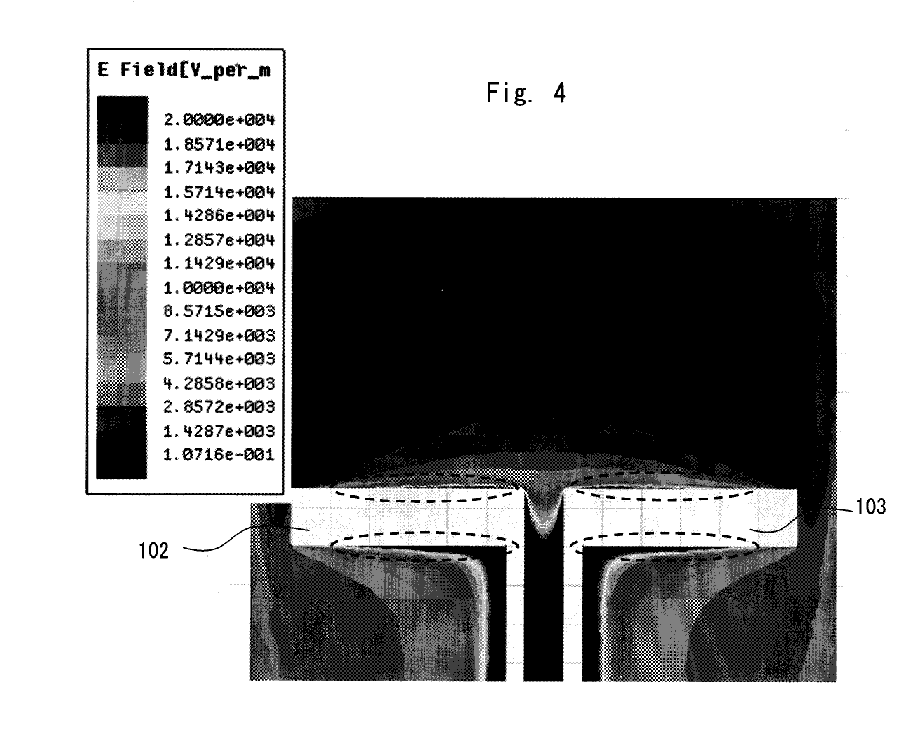

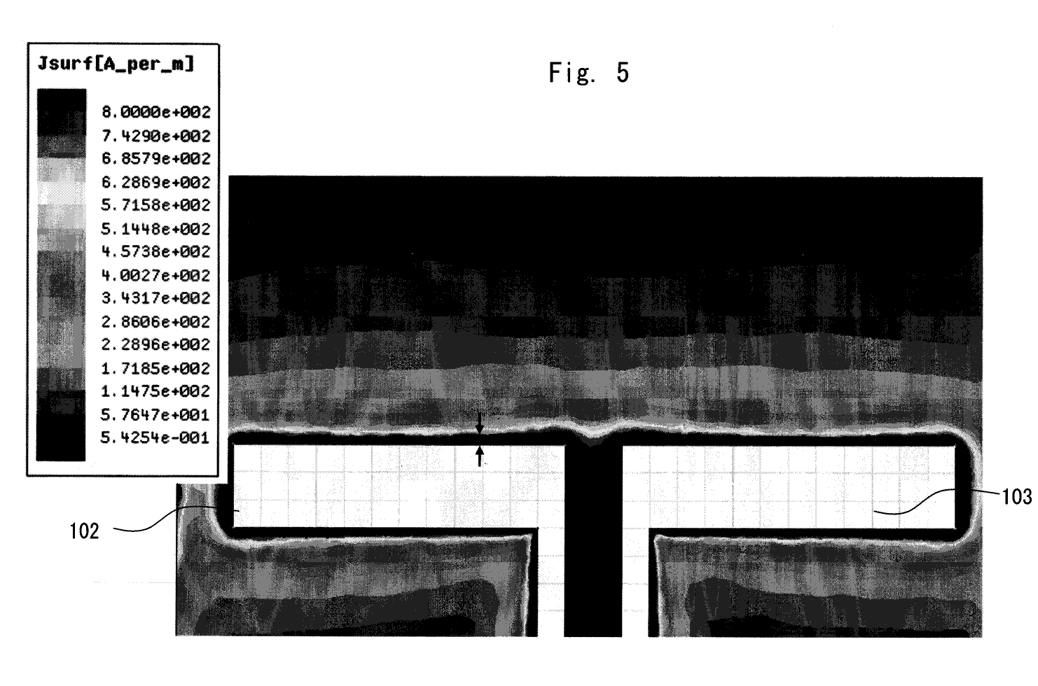

FIG. 4 shows the simulation result of an electric field (absolute value) distribution of the planar antenna apparatus of the comparative example shown in FIG. 3A. FIG. 5 shows the simulation result of a current distribution of the planar antenna apparatus of the comparative example shown in FIG. 3A. As can be seen from FIG. 4 in the dotted line ellipses, large electric fields are generated along each long side of the slots (openings) 102 and 103. Note that positive/negative is inverted around a ground potential (GND) between the two long sides of each slot. Although FIG. 5 shows that current flows along a periphery of the slots 102 and 103, a width of a current path around the slots 102 and 103 of FIG. 5 is about 100

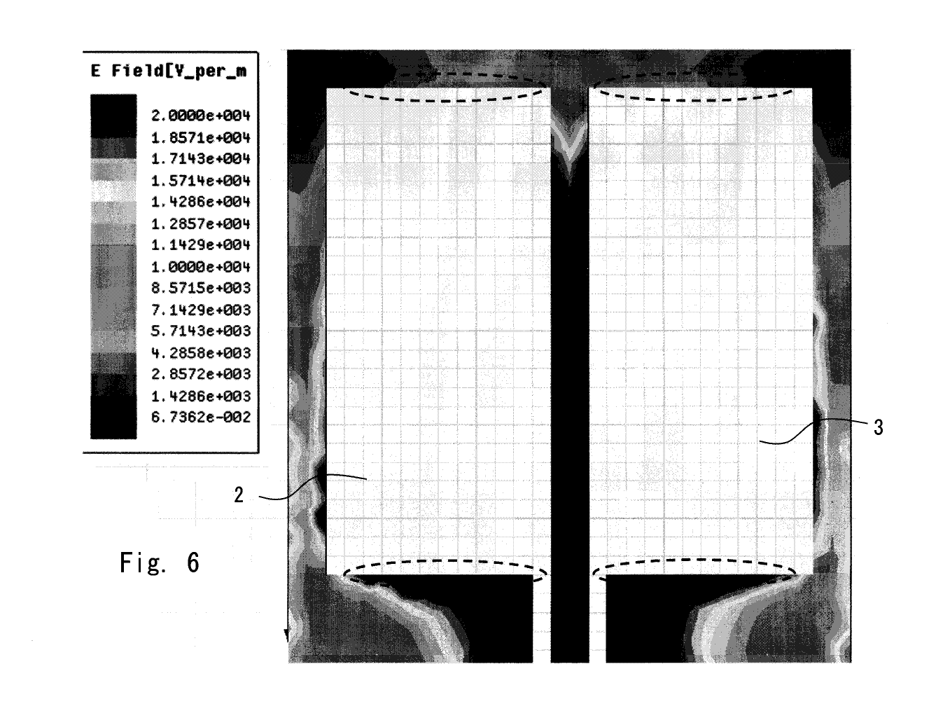

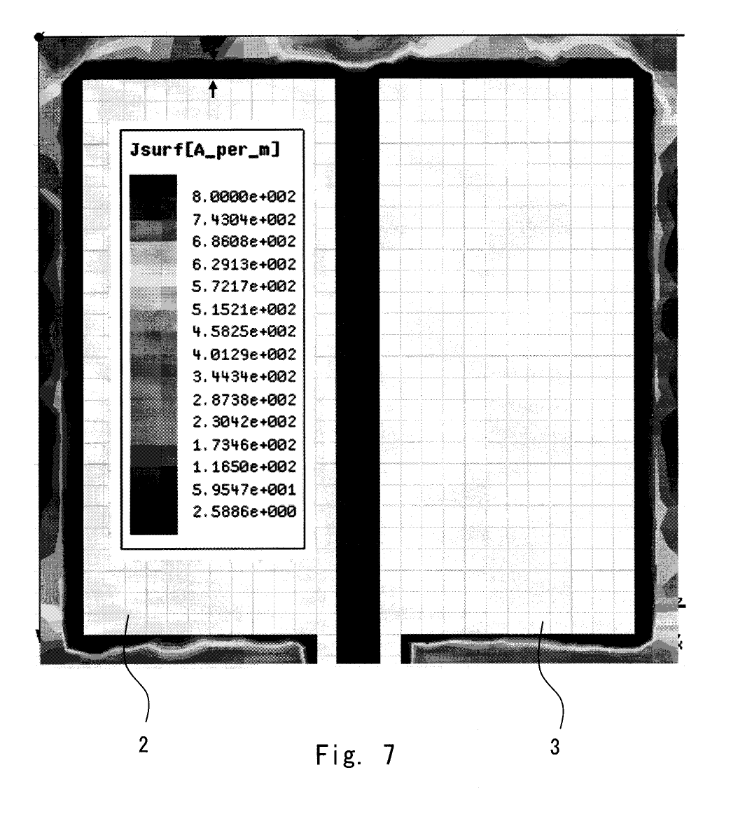

On the other hand, FIG. 6 shows the simulation result of an electric field (absolute value) distribution of the planar antenna apparatus according to this embodiment shown in FIG. 3B. FIG. 7 shows the simulation result of a current distribution of the planar antenna apparatus according to this embodiment shown in FIG. 3B. As can be seen from FIG. 6 in the dotted line ellipses, electric fields generated along the long sides of the slots (openings) 2 and 3 (especially long sides of the upper part of FIG. 6) are weaker as compared to FIG. 4. That is, in FIG. 6, the electric field distribution which appears in the slot dipole antenna does not exist. As can be seen from FIG. 7, current flows through the peripheral conductors 11 to 14 along the periphery of the slots 2 and 3. A width of a current path around the slots 2 and 3 of FIG. 7 is about 200 μm, and is expanded about twice the width in FIG. 5. Therefore, it is considered that the antenna apparatus of FIG. 3B has the radiation characteristics of the loop antenna which is based on the magnetic field.

The following conclusion can be drawn by the simulation results shown in FIGS. 4 to 7. Specifically, by expanding the area of the openings 2 and 3 as in the antenna apparatus of FIG. 3B, a radiation characteristics changes from the slot dipole antenna operation to the loop antenna operation.

Next, an advantage in terms of the radiation efficiency of the planar antenna apparatus according to this embodiment is explained. As shown in the formula (3), the radiation resistance Ra of the planar slot dipole antenna depends on the antenna length L. However, the antenna length L cannot be sufficiently extended from the necessity of reserving the area of the peripheral conductor of the antenna unit 101 of FIG. 11. On the other hand, in the layout of the antenna unit 1 shown in FIG. 1, as the area of the peripheral conductors 11 to 14 is reduced in an attempt to expand the area of the openings 2 and 3, the antenna length L1 and the antenna width W1 of FIG. 1 can be extended respectively from the antenna length L and the antenna width W of FIG. 11.

Further, as for the radiation characteristics of the antenna unit 1, the radiation resistance is proportional to the opening area and will be close characteristics to the loop antenna that does not require an infinite conductor. Suppose that both opening areas of the opening 2 (the first loop) and the opening 3 (the second loop) are A and the number of the openings (loops) is two, the radiation resistance R_{R} of the antenna unit 1, which is considered to be a loop antenna, can be represented by a formula (4). Specifically, the radiation resistance R_{R} of the antenna unit 1 is proportional to the square of the opening area A of each of the first and second loop.

$${R}_{R} = 320 {π}^{4} \frac{{2}^{2} \cdot {A}^{2}}{{λ}^{4}} \qquad ( 4 )$$

Next, if the loop antenna length L1 of FIG. 1 is assumed to be equal to the antenna length L of FIG. 11, a ratio of the radiation resistance Ra of the antenna unit 101 of FIG. 11 to the radiation resistance R_{R} of the antenna unit 1 of FIG. 1 is represented by a formula (5).

Ra/R_{R}=L²·λ²/16π²·L²·(W1)² (5)

From the formula (5), a condition of the antenna width W1 for the radiation resistance R_{R} to exceed the radiation resistance Ra can be represented by a formula (6).

λ/4π≦W1 (6)

In the formula (5), it is assumed that the antenna length L1 of FIG. 1 is equal to the antenna length L of FIG. 11. However, as described above, in this embodiment, since the width of the peripheral conductors 12 and 14 can be reduced, the antenna length L1 of FIG. 1 can be made longer than antenna length L of FIG. 11. Accordingly, when the antenna width W1 of FIG. 1 satisfies at least the condition shown in the formula (6), the radiation resistance R_{R} of the antenna unit 1 according to this embodiment will be larger than the radiation resistance R_{R} of the antenna unit 101 of FIG. 11.

### Second Embodiment

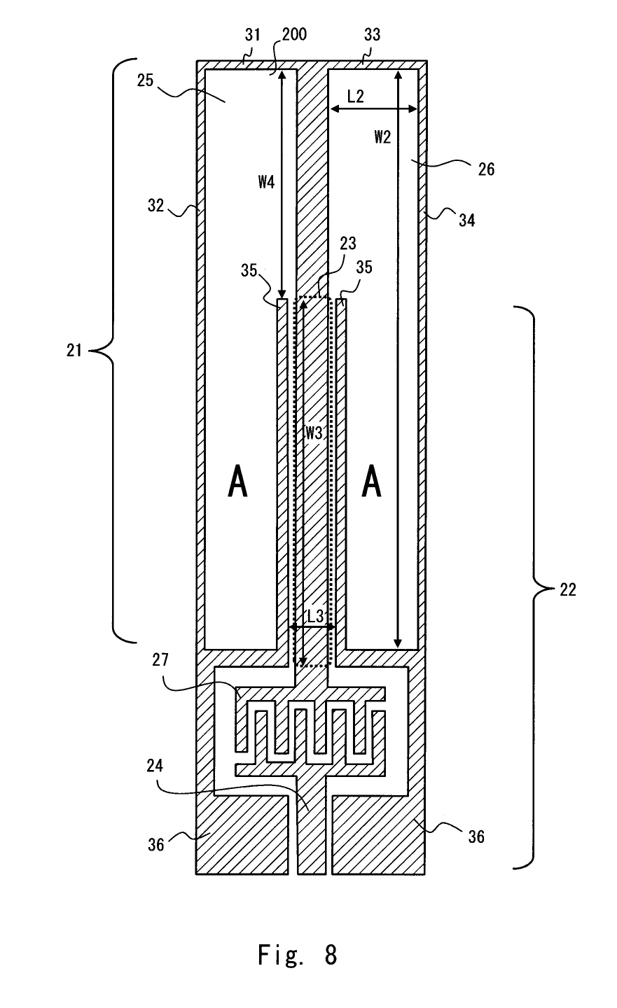

FIG. 8 is a plan view showing an example of a configuration of a planar antenna apparatus according to the second embodiment of the present invention. A schematic configuration of the antenna apparatus of FIG. 8 is the same as that of the planar antenna apparatus shown in FIGS. 11 and 12. To be specific, the antenna unit 21 is formed by providing openings (slots) 25 and 26 in a GND conductor 36, which is formed by a conductor pattern placed over a dielectric substrate 200. The lower layer dielectric substrate 200 is exposed in the openings 25 and 26 shown in FIG. 8. The openings 25 and 26 are arranged axis-symmetrically with respect to a transmission line 23. In the example of FIG. 8, the transmission line 23 is a coplanar waveguide. The antenna unit 21 is connected to an external circuit (signal source) via a matching unit 22.

However, specific arrangement, shape, and opening area of the openings 25 and 26 of the planar antenna apparatus according to this embodiment shown in FIG. 8 are different from the ones shown in FIG. 11. More specifically, in this embodiment, a width of peripheral conductors (conductors 31 to 34) of the antenna unit 21 is narrowed to the extent that is not influenced by a skin effect, i.e. current reduction due to an insufficient surface depth, at a desired radio frequency. Then, the opening area of the openings 25 and 26 is expanded. By adopting such configuration, the radiation characteristics (that is, magnetic field radiation type) of a tiny loop antenna, not the radiation characteristics (that is, electric field radiation type) of a tiny dipole antenna, dominate the radiation characteristics of the antenna unit 21. It is considered that this radiation characteristics are brought about by loop current (a first loop) which flows through the peripheral conductors 31 and 32 of the opening 25, and loop current (a second loop) which flows through the peripheral conductors 33 and 34 of the opening 26.

Further, the planar antenna apparatus of FIG. 8 has a shape in which the conductors in the peripheral region (region A in FIG. 8) of the transmission line 23 are removed, and elongate open stubs 35 project from the GND conductor 36 inside the openings 25 and 26. The open stubs 35 are adjusted to the length which is shortened according to a perimeter length of the openings 25 and 26 on the basis of ¼ of a desired radio signal wavelength (i.e. λ/4). By providing the open stub 35, the shape of the loop antenna formed by the opening 25 and the stub 35 can be brought close to a quadrangle. Then the opening area of the openings 25 and 26 is further expanded. This applies to another loop antenna formed by the opening 26 and the stub 35.

By appropriately changing the length of the open stub 35, the electrical length of the loop antenna can be easily adjusted and it is easier to match the desired frequency (resonance frequency). Accordingly, the open stub 35 has a role of a return path for return current C5 and C6 described later, and also a role of matching the electrical length of the loop antenna to the desired frequency. As the electrical length of the loop antenna can be adjusted by the length of the open stub, advantages can be achieved, such as reduction of designing period.

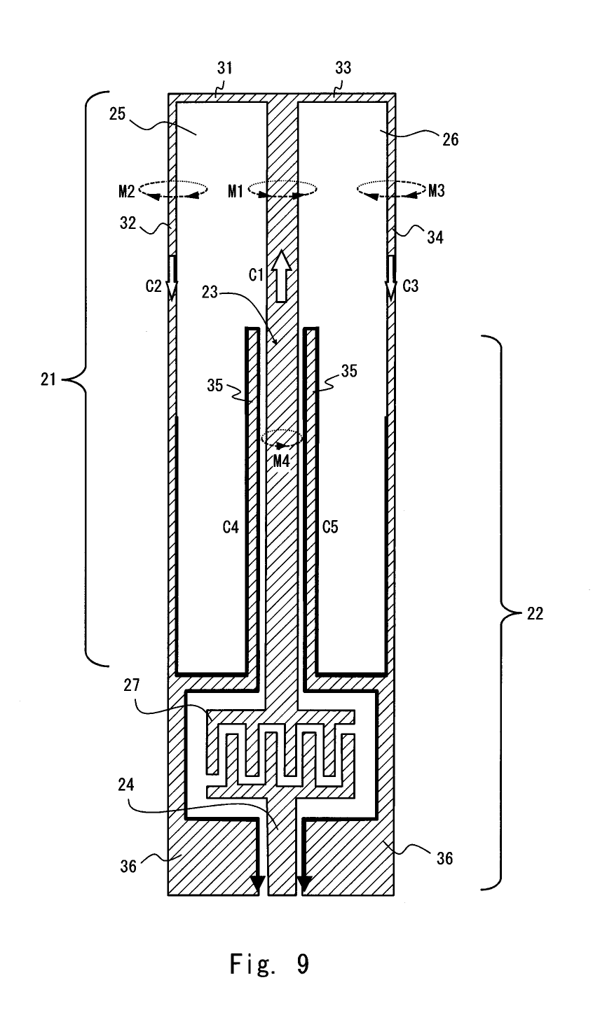

The state of magnetic field radiation of the antenna unit 1 is explained hereinafter. FIG. 9 shows loop current flowing through the antenna unit 21 and magnetic fields generated by the loop current when a signal is supplied to the antenna unit 21 from the signal line 24 via the matching unit 22. In connection with the signal supply to the antenna unit 21, the forward current C1 is generated in the transmission line 23. The forward current C1 generates a forward magnetic field Ml. The forward current C1 is divided into the return current C2 which flows through the peripheral conductors 31 and 32 (the first loop) of the opening 25, and the return current C3 which flows through the peripheral conductors 33 and 34 (the second loop) of the opening 26. A return magnetic field M2 in the first loop is generated by the return current C2 which flows through the first loop. Similarly, a return magnetic field M3 in the second loop is generated by the return current C3 which flows through the second loop. Due to the return magnetic fields M2, M3, and the forward magnetic field M1, magnetic flux is localized in the region in the antenna unit 1 excluding the transmission line 23 (the region not opposing the line 23 of the openings 25 and 26), and strong electromagnetic waves are emitted to space.

The magnetic field is cancelled out at the position of the matching unit 22 by the return magnetic field M2 in the first loop and the return magnetic field M3 in the second loop. Therefore, the layout of arranging the openings 25 and 26 axis-symmetrically with respect to the transmission line 23 reduces the influence of the magnetic field to the matching unit 22 from the antenna unit 21. At this time, in order to reduce a leakage of the electromagnetic field in the matching unit 22, the transmission line 23 is used. That is, the return current C2 and C3 flow through the shortest path to the GND conductor 36 along the conductor edge due to the nature of the high-frequency current. Therefore, the main return currents C5 and C6, which are opposite direction to the forward current C1, flow the surface of the stub 35. Then, it is possible to suppress propagation of the magnetic field M4 in the transmission line 23 and also disorder of electromagnetic wave radiation of the antenna unit 21.

Except for the case of performing a band design, characteristic impedance of the transmission line 23 is not important, but the electrical length θ is. For this reason, the width of the GND conductor (stub) 35 as the transmission line 23, that is a coplanar waveguide, does not need twice the width of the conductor interval L3 in the transmission line 23. Accordingly, the necessary area of the matching unit 22 can be reduced. By placing the matching unit 22, which has a reduced area due to the reduction of the width of the stub 35, in the antenna unit 21, it is possible to bring close the periphery of the two loop antennas formed by the first loop along the opening 25 and the second loop along the opening 26 to λ/2, and also to expand the opening area. Then, stronger resonance is obtained, and the forward current C1, the return current C2 in the first loop, and the return current C3 in the second loop increase.

Note that the width of the open stub 35 is conditional on not being influenced by the skin effect (current reduction due to the insufficient surface depth). Since the open stubs 35 are placed in the openings 25 and 26, an electromagnetic field generated in the transmission line 23 does not influence the circumference. Further, the magnetic field from the first and the second loop has the weakest magnetic flux density in the intermediate position of these two loops. Therefore, even if the transmission line 23 is placed in the intermediate position of these two loops, the transmission line 23 and an antenna do not disturb operations each other. The transmission line 23 is sandwiched between the first and the second loop. Current with substantially the same direction and size, which is indicated by the return current C2 in the first loop and the return current C3 in the second loop in FIG. 8 flows through the two loops.

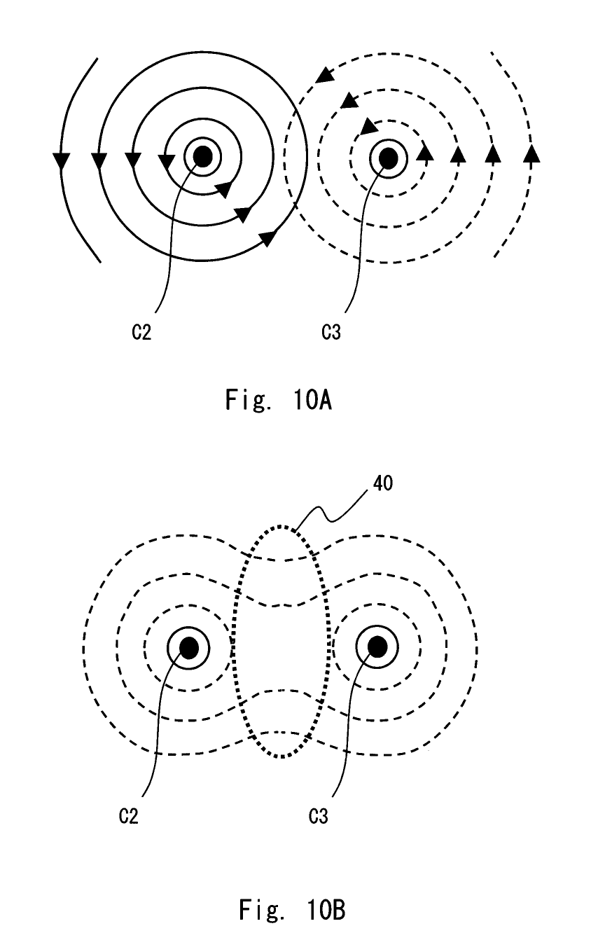

FIG. 10A illustrates the direction of the magnetic field of the antenna unit 21 in FIG. 8. FIG. 10A illustrates the magnetic field by the return current C2 in the first loop and the direction thereof, and the magnetic field by the return current C3 in the second loop and the direction thereof. As the direction of the magnetic field differs in the part where the two the magnetic fields by return currents C2 and C3 are intersect, that is, the part where the first and the second loop magnetic fields overlap, the magnetic field is cancelled out.

FIG. 10B illustrates magnetic flux density of the part of the transmission line 23 in FIG. 8. A region surrounded by an ellipse 40 in FIG. 10B is corresponds to the position of the transmission line 23. At the position of the transmission line 23, the magnetic flux density is reduced by cancelling out the magnetic field from the first and the second loop. That is, the influence on the transmission line 23 is reduced. On the other hand, the directions of the return current C2 in the first loop and the return current C3 in the second loop are different from the direction of the forward current C1 flowing through the transmission line 23. Thus the magnetic flux density increases in the intermediate position between the two loops and the transmission line 23, and the radiation of the magnetic field to space is increased. This achieves favorable loop antenna characteristics. Accordingly, there is no adverse effect to the magnetic field radiation characteristics by having provided the transmission line 23 (two stubs 35) in the openings 25 and 26.

Next, an advantage in terms of the radiation efficiency of the planar antenna apparatus according to this embodiment is explained hereinafter. The radiation resistance R_{R} of the antenna unit 21 according to this embodiment is larger than the radiation resistance R_{R} of the antenna unit 101 of FIG. 11 in a similar way as the antenna unit 1 according to the first embodiment. Therefore, as shown in the formula (3), the radiation resistance Ra of the planar slot dipole antenna depends on the antenna length L. However, the antenna length L cannot be sufficiently extended from the necessity of reserving the area of the peripheral conductor of the antenna unit 101 of FIG. 11. On the other hand, in the layout of the antenna unit 21 shown in FIG. 8, since the area of the peripheral conductors 31 to 34 is reduced in an attempt to expand the area of the openings 25 and 26, the antenna length L2 and the antenna width W2 of FIG. 8 can be extended respectively from the antenna length L and the antenna width W of FIG. 11.

Further, as for the radiation characteristics of the antenna unit 21, the radiation resistance is proportional to the opening area and will be close characteristics to the loop antenna that does not require an infinite conductor. Suppose that both opening areas of the opening 25 (the first loop) and the opening 26 (the second loop) are A and the number of the openings (loops) is two, the radiation resistance R_{R} of the antenna unit 21, which is considered to be a loop antenna, can be represented by a formula (7), in a similar manner as the abovementioned formula (4). Specifically, the radiation resistance R_{R} of the antenna unit 21 is proportional to the square of the opening area A of each of the first and the second loop.

$${R}_{R} = 320 {π}^{4} \frac{{2}^{2} \cdot {A}^{2}}{{λ}^{4}} \qquad ( 7 )$$

Next, if the loop antenna length L2 of FIG. 8 is assumed to be equal to the antenna length L of FIG. 11, a ratio of the radiation resistance Ra of the antenna unit 101 of FIG. 11 to the radiation resistance R_{R} of the antenna unit 21 of FIG. 1 is represented by a formula (8).

Ra/R_{R}=L²·λ²/16π²·L²·(W2)² (8)

From the formula (8), a condition of the antenna width W2 for the radiation resistance R_{R} to exceed the radiation resistance Ra can be represented by a formula (9).

λ/4π≦W2 (9)

In the formula (8), it is assumed that the antenna length L2 of FIG. 8 is equal to the antenna length L of FIG. 11. However, as described above, in this embodiment, since the width of the peripheral conductors 32 and 34 can be reduced, the antenna length L2 of FIG. 8 can be made longer than antenna length L of FIG. 11. Accordingly, in a similar manner as the antenna unit 1 of FIG. 1 explained in the first embodiment, when the antenna width W2 of FIG. 8 satisfies at least the condition shown in the formula (9), the radiation resistance R_{R} of the antenna unit 21 according to this embodiment will be larger than the radiation resistance R_{R} of the antenna unit 101 of FIG. 11. Moreover, in the configuration of FIG. 8, the conductors around the transmission line 23 (region A of FIG. 8) are removed, and the width W2 of the openings 25 and 26 is also extended. Therefore, the radiation resistance R_{R} of the antenna unit 21 can be further increased.

In order to bring the resonance frequency of the loop antenna close to the desired frequency, it is necessary to bring the perimeter length of the first loop and the second loop close to λ/2. A formula (10) represents the perimeter length of the slots 102 and 103 provided in the antenna unit 101 of FIG. 11.

2(L+W) (10)

In order to bring each perimeter length of each slot 102 and 103 to λ/2 while maintaining the same area as the antenna apparatus of FIG. 11, the peripheral conductor area of the transmission line 104 in FIG. 11 may be removed, and the perimeter length of the removed peripheral conductor may be added to the perimeter length of the slots 102 and 103. That is, the shape of the antenna unit 21 of the antenna apparatus (FIG. 8) according to this embodiment may be adopted.

The length of the transmission line 23 including the open stub 35 may be determined by resonating with the antenna by multiplying a coefficient of contraction a, which is determined by the perimeter length of the antenna unit 21 and the antenna width W2 or the like, by a reference value based on ¼ of the desired radio signal wavelength (λ/4). The perimeter of the openings (slots) 25 and 26 of FIG. 8 can be respectively represented by formulas (11) and (12) using the antenna length L2, the antenna width W2, a part of the antenna perimeter length W4, and the coefficient of contraction α. If the formula (12) is compared with the formula (10), the formula (12) can extend the slot perimeter more than the formula (10), and it will be easy to bring the slot perimeter to λ/2. Accordingly, the resonance can flow larger current to the antenna unit 21.

W2=α(λ/4)+W4 (11)

2(L2+W2)≅λ/2 (12)

In FIG. 8, the characteristic impedance of the transmission line 23 may be designed on the condition that the GND conductor 36 is an infinite planar conductor. However, in practice, since the GND conductor 36 is a finite conductor, it is preferable to take a deviation from a theoretical value into consideration. For example, the width of the open stub 35 may be twice or more than the GND conductor interval L3 in the transmission line 23. When it is not required to consider the characteristic impedance, only the length W3 of the transmission line 23 is important. Thus the width of the open stub 35 may be further reduced to the width that is not influenced by the skin effect. The first and second embodiments can be combined as desirable by one of ordinary skill in the art.

While the invention has been described in terms of several embodiments, those skilled in the art will recognize that the invention can be practiced with various modifications within the spirit and scope of the appended claims and the invention is not limited to the examples described above. Further, the scope of the claims is not limited by the embodiments described above. Furthermore, it is noted that, Applicant's intent is to encompass equivalents of all claim elements, even if amended later during prosecution.

What is claimed is:

1. A planar antenna apparatus comprising:
a dielectric substrate;
a ground conductor that is formed by a conductor pattern and includes a first and a second opening, the conductor pattern being placed to a surface of the dielectric substrate; and
a transmission line that is formed by the conductor pattern and supplies a signal to a first and a second peripheral conductor respectively surrounding the first and the second opening,
wherein the first and the second opening are arranged axis-symmetrically with respect to the transmission line,
opening areas of the first and the second opening are determined so that, due to loop currents that are supplied by the transmission line and flow through the first and the second peripheral conductor, a region including the first opening and the first peripheral conductor operates as a first loop radiating element of a magnetic field radiation type, and a region including the second opening and the second peripheral conductor operates as a second loop radiating element of the magnetic field radiation type.

2. The planar antenna apparatus according to claim 1, wherein the transmission line is a coplanar waveguide.

3. The planar antenna apparatus according to claim 2, wherein the coplanar waveguide is placed to extend between the first and the second opening.

4. The planar antenna apparatus according to claim 3, wherein the coplanar waveguide comprises:
a center conductor that is coupled to an external circuit; and
a first and a second open stub that extend from the ground conductor and are arranged to both sides of the center conductor in parallel with the center conductor.

5. The planar antenna apparatus according to claim 1, wherein widths of the first and the second peripheral conductor are determined so as not to disturb flows of the loop currents by an insufficient surface depth at a center frequency of the signal.

6. A planar antenna apparatus comprising:
a dielectric substrate;
a ground conductor that is formed by a conductor pattern and includes a first and a second opening, the conductor pattern being placed to a surface of the dielectric substrate; and
a coplanar waveguide that is formed by the conductor pattern, arranged to extend between the first and the second opening, and supplies a signal to a first and a second peripheral conductor respectively surrounding the first and the second opening,
wherein the first and the second opening are arranged axis-symmetrically with respect to the coplanar waveguide.

7. The planar antenna apparatus according to claim 6, wherein the coplanar waveguide comprises:
a center conductor that is coupled to an external circuit; and
a first and a second open stub that extend from the ground conductor and are arranged to both sides of the center conductor in parallel with the center conductor.

8. The planar antenna apparatus according to claim 6, wherein the planar antenna apparatus operates as a loop antenna of a magnetic field radiation type by loop currents supplied by the coplanar waveguide and flows through the first and the second peripheral conductor.

9. The planar antenna apparatus according to claim 6, wherein widths of the first and the second peripheral conductors are determined so as not to disturb flows of the loop currents by an insufficient surface depth at a center frequency of the signal.
